(19) United States
(12) Patent Application Publication
(10) Pub. No.: US 2026/0173041 A1
(43) Pub. Date: Jun. 18, 2026

(54) METHODS AND APPARATUSES FOR DETERMINING A FORMAT OF A SYMBOL

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 19/127,676

(22) PCT Filed: Nov. 7, 2022
(86) PCT No.: PCT/CN2022/130326

§ 371 Date: May 6, 2025

(51) Int. Cl. H04W 72/0446; H04L 5/00

(52) U.S. Cl. CPC H04W 72/0446; H04L 5/0007

(57) ABSTRACT

The present disclosure relates to methods and apparatuses for determining a format of a symbol. An embodiment of the present disclosure provides a user equipment (UE), comprising: a transceiver; and a processor coupled with the transceiver and configured to: receive a configuration indicating a set of subband full duplex (SBFD) symbols, wherein a symbol of the set of SBFD symbols is indicated as a first format by a first signaling; receive a second signaling indicating a second format of the symbol; and determine a format of the symbol based on the first format and the second format.

### TECHNICAL FIELD

The present disclosure relates to wireless communication, and particularly relates to methods and apparatuses for methods and apparatuses for determining a format of a symbol.

### BACKGROUND OF THE INVENTION

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In a wireless communication system, a base station (BS) in a full duplex mode may perform data transmission with a user equipment (UE). There is a need for determining a format of a symbol in a full duplex system.

### SUMMARY

An embodiment of the present disclosure provides a user equipment (UE), comprising: a transceiver; and a processor coupled with the transceiver and configured to: receive a configuration indicating a set of subband full duplex (SBFD) symbols, wherein a symbol of the set of SBFD symbols is indicated as a first format by a first signaling; receive a second signaling indicating a second format of the symbol; and determine a format of the symbol based on the first format and the second format.

In some embodiments, the first format indicates that the symbol is a downlink (DL) symbol, and the processor is further configured to perform one of the following: determine the format of the symbol as DL for DL reception in the case that the second format indicates that the symbol is a DL symbol; determine the symbol as a SBFD symbol in the case the second format indicates that the symbol is a UL symbol or a flexible symbol; or determine the symbol as a SBFD symbol or determine the format of the symbol as DL for DL reception flexibly in the case that the second format indicates the symbol is a flexible symbol.

In some embodiments, the first format indicates that the symbol is a DL symbol, and the second format indicates that the symbol is a flexible symbol, and the processor is further configured to: receive a third signaling indicating a third format of the symbol; and determine the format of the symbol based on the third format.

In some embodiments, the processor is further configured to perform one of the following: determine the format of the symbol as DL for DL reception in the case that the third format indicates that the symbol is a DL symbol; determine the symbol as a SBFD symbol in the case that the third format indicates the symbol is a UL symbol; or determine the symbol as a SBFD symbol or determine the format of the symbol as DL for DL reception flexibly in the case that the third format indicates the symbol is a flexible symbol.

In some embodiments, the first format indicates that the symbol is a flexible symbol, and the processor is further configured to perform one of the following: determine the symbol as a SBFD symbol in the case the second format indicates the symbol is one of a DL symbol, or a flexible symbol; determine the format of the symbol as UL for UL transmission in a UL bandwidth part (BWP) in the case the second format indicates the symbol is a UL symbol; determine the format of the symbol as DL for DL reception in the case the second format indicates the symbol is a DL symbol; or determine the symbol as a SBFD symbol or determine the format of the symbol as DL for DL transmission flexibly in the case that the second format indicates the symbol is a flexible symbol.

In some embodiments, the first format indicates that the symbol is a flexible symbol, and the second format indicates that the symbol is a flexible symbol, and the processor is further configured to: receive a third signaling indicating a third format of the symbol; and determine the format of the symbol based on the third format.

In some embodiments, the processor is further configured to perform one of the following: determine the format of the symbol as DL for DL reception in the case that the third format indicates the symbol is a DL symbol; determine format of the symbol as UL for UL transmission in a UL BWP in the case that the third format indicates the symbol is a UL symbol or a flexible symbol; or determine the format of the symbol as a SBFD symbol or as DL for DL reception flexibly in the case that the third format indicates the symbol is a flexible symbol.

In some embodiments, the third signaling includes a DL control information (DCI) signaling.

In some embodiments, the configuration for the SBFD symbols includes a cell common signaling, the first signaling includes a cell common signaling, and the second signaling includes a UE specific radio resource control (RRC) signaling.

In some embodiments, the configuration for the SBFD symbols includes a UE specific RRC signaling, the first signaling includes a UE specific RRC signaling, and the second signaling includes a DCI signaling.

Another embodiment of the present disclosure provides a base station (BS), comprising: a transceiver; and a processor coupled with the transceiver and configured to: generate a configuration indicating a set of subband full duplex (SBFD) symbols wherein a symbol of the set of SBFD symbols is indicated as a first format by a generated first signaling; generate a second signaling indicating a second format of the symbol; and transmit the configuration, the first signaling and the second signaling to a user equipment (UE).

In some embodiments, the first format indicates that the symbol is a DL symbol, and the second format indicates that the symbol is a flexible symbol, and the processor is further configured to: generate a third signaling indicating a third format of the symbol; and transmit the third signaling to the UE.

In some embodiments, the third signaling includes a DL control information (DCI) signaling.

In some embodiments, the configuration for the SBFD symbols includes a cell common signaling, the first signaling includes a cell common signaling, and the second signaling includes a UE specific radio resource control (RRC) signaling.

In some embodiments, the configuration for the SBFD symbols includes a UE specific RRC signaling, the first signaling includes a UE specific RRC signaling, and the second signaling includes a DCI signaling.

Yet another embodiment of the present disclosure provides a method performed by a user equipment (UE), comprising: receiving a configuration indicating a set of subband full duplex (SBFD) symbols, wherein a symbol of the set of SBFD symbols is indicated as a first format by a first signaling; receiving a second signaling indicating a second format of the symbol; determining a format of the symbol based on the first format and the second format.

Still another embodiment of the present disclosure provides a method performed by a base station (BS), comprising: generating a configuration indicating a set of subband full duplex (SBFD) symbols, wherein a symbol of the set of SBFD symbols is indicated as a first format by a generated first signaling; generating a second signaling indicating a second format of the symbol; and transmitting the configuration, the first signaling, and the second signaling to a user equipment (UE).

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIGS. 2A-2C illustrate three different duplex modes according to some embodiments of the present disclosure.

FIG. 3 illustrates an example for SBFD according to some embodiments of the present disclosure.

FIG. 4 illustrates a TDD slot format determined based on a cell common UL/DL configuration according to some embodiments of the present disclosure.

FIG. 5A-5C illustrate some methods of determining the format of symbols according to some embodiments of the present disclosure.

FIG. 6A-6C illustrate some methods of determining the format of symbols according to some embodiments of the present disclosure.

FIG. 7A-7C illustrate some methods of determining the format of symbols according to some embodiments of the present disclosure.

FIG. 8 illustrates a method performed by a UE for determining a format of a symbol according to some embodiments of the present disclosure.

FIG. 9 illustrates a method performed by a BS for determining a format of a symbol according to some embodiments of the present disclosure.

FIG. 10 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3rd generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 depicts a wireless communication system 100 according to an embodiment of the present disclosure.

As shown in FIG. 1, the wireless communication system 100 includes two UEs, UE 101-A and UE 101-B, and a BS 102. Even though a specific number of UEs and BSs are depicted in FIG. 1, it is contemplated that any number of UEs and BSs may be included in the wireless communication system 100.

The UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs include wearable devices, such as smart watches, fitness bands, optical head-mounted displays, or the like. Moreover, the UEs may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs may communicate directly with the BSs via uplink (UL) communication signals.

The BSs may be distributed over a geographic region. In certain embodiments, each of the BSs may also be referred to as an access point, an access terminal, a base, a macro cell, a Node-B, an enhanced Node B (eNB), a gNB, a Home Node-B, a relay node, or a device, or described using other terminology used in the art. The BSs are generally part of a radio access network that may include one or more controllers communicably coupled to one or more corresponding BSs.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In one embodiment, the wireless communication system 100 is compatible with the 5G new radio (NR) of the 3GPP protocol, wherein the BSs transmit data using an orthogonal frequency division multiplexing (OFDM) modulation scheme on the downlink and the UEs transmit data on the uplink using discrete Fourier transform-spread-orthogonal frequency division multiplexing (DFT-S-OFDM) or cyclic prefix-orthogonal frequency division multiplexing (CP-OFDM) scheme. More generally, however, the wireless communication system 100 may implement some other open or proprietary communication protocols, for example, WiMAX, among other protocols.

In other embodiments, the BSs may communicate using other communication protocols, such as the IEEE 802.11 family of wireless communication protocols. Further, in some embodiments, the BSs may communicate over licensed spectrums, whereas in other embodiments the BSs may communicate over unlicensed spectrums. The present disclosure is not intended to be limited to the implementation of any particular wireless communication system architecture or protocol. In another embodiment, the BSs may communicate with the UEs using the 3GPP protocols.

In some embodiments, the BS may perform duplex communication. In wireless communication system, duplex communication means bidirectional communication between two devices, where the transmissions over the link in each direction may take place at the same time (i.e., full duplex) or mutual exclusive time (i.e., half duplex). That is, there are two types of duplex communication, one is the full duplex, which suggests that the transmissions over the link in each direction may take place at the same time, the other is half duplex, which means that the transmissions over the link in each direction may take place at mutual exclusive time.

For a full duplex transceiver, different carrier frequencies may be employed for each link direction. This is known as full duplex frequency division duplex (FD-FDD). Conversely, in half-duplex (HD) transceiver, the link directions are separated by time domain resources. When the same carrier frequency is used for each link direction, the HD transceiver is referred as TDD system, while if different carrier frequencies are used, the system is known as half duplex FDD (HD-FDD).

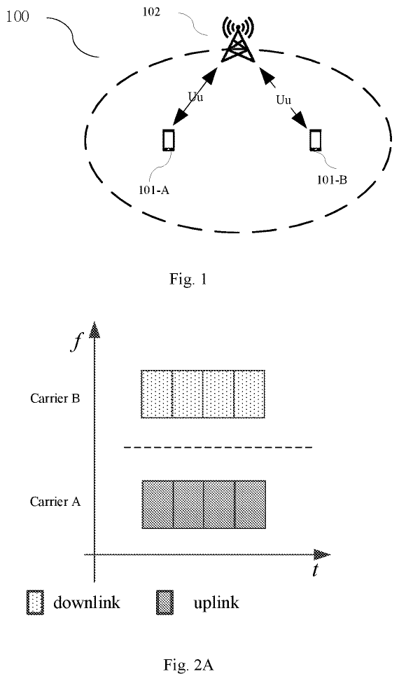

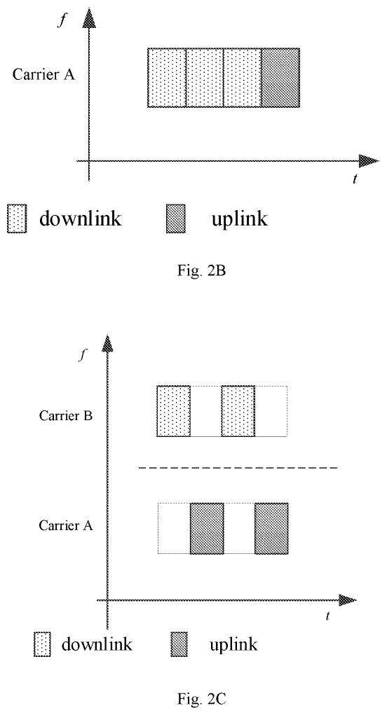

FIGS. 2A-2C illustrate three different duplex modes according to some embodiments of the present disclosure.

FIG. 2A illustrates a full duplex frequency division duplex (FD-FDD) mode. In the FD-FDD mode, the link directions are separated by frequency domain resources. The uplink data is transmitted with carrier A, and the downlink data is transmitted with carrier B, different carrier frequencies are employed for different link directions, respectively. The full duplex is achieved by different carrier frequencies.

FIG. 2B illustrates a time division duplex (TDD) mode. In the TDD mode, the link directions are separated by time domain resources. For instance, the downlink transmission is performed in the first three slots on carrier A, and the uplink transmission is performed in the last slot on carrier A.

FIG. 2C illustrates a half-duplex FDD (HD-FDD) mode. In the HD-FDD mode, the uplink transmission and downlink transmission are performed on different frequencies within different time duration. As shown in FIG. 2C, the downlink transmission is performed in the first slot and the third slot in time domain on carrier B, and the uplink transmission is performed in the second slot and the fourth slot in time domain on carrier A.

Advanced full duplex modes may enable simultaneous transmission and reception by the same device on the same carrier, which may potentially double the link throughput. Besides, the transmission latency is also reduced due to simultaneous bidirectional transmission. However, simultaneous DL and UL in the same carrier may incur self-interference. At the BS side, the DL transmission may contaminate the UL reception, while at the UE side, the UL transmission might contaminate DL reception.

In practice, it is more feasible to implement full duplex at the BS side than at the UE side, because there is more space available at the BS side, so that the transmit or receive antenna branches can be separated for self-interference cancellation. Besides, the BS may apply more advanced receiver, which is fundamental for self-interference cancellation.

Therefore, one scenario is that only the BS may perform in the full duplex mode, while the UE may still perform in the half duplex mode. This means that in some slots, the BS may perform DL transmission to some UEs, and also perform UL reception from other UEs. In addition, besides the schemes described in above, non-overlapping frequency resources could be allocated for DL transmission (to some UEs) and UL reception (from other UEs) to mitigate self-interference. From UEs'point of view, the UEs could be categorized to be SBFD aware UEs (i.e., aware full duplex in BS side) and SBFD non-aware UEs, depending on UE capability.

One practical usage scenario is to use full duplex to enhance UL performance in TDD systems. A UL subband may be configured in some the DL symbols or some flexible symbols, so that more resources are available for UL transmission. Such full duplex framework is known as subband full duplex (SBFD). For SBFD aware UEs configured with UL subband, the DL symbols and flexible symbols with UL subband are named as SBFD symbols hereinafter. In a SBFD symbol, a UL signal or channel, e.g., a physical uplink shared channel (PUSCH) (for a SBFD aware UE) may be scheduled in the UL subband(s), while a DL signal or channel, e.g., a physical downlink shared channel (PDSCH) (for a SBFD non-aware UE) could be scheduled in the physical resources out of subband. In some embodiment, for a symbol configured as SBFD symbol for a SBFD-aware UE, only UL transmission is allowed for the UE in this symbol. As an alternative, both UL and DL transmissions are allowed in this symbol for the SBFD aware UE. As another alternative, for a DL symbol configured as SBFD symbol for a SBFD-aware UE, only UL transmission is allowed, while for a flexible symbol configured as SBFD symbol for a SBFD-aware UE, both DL and UL transmissions are allowed in this symbol for the UE.

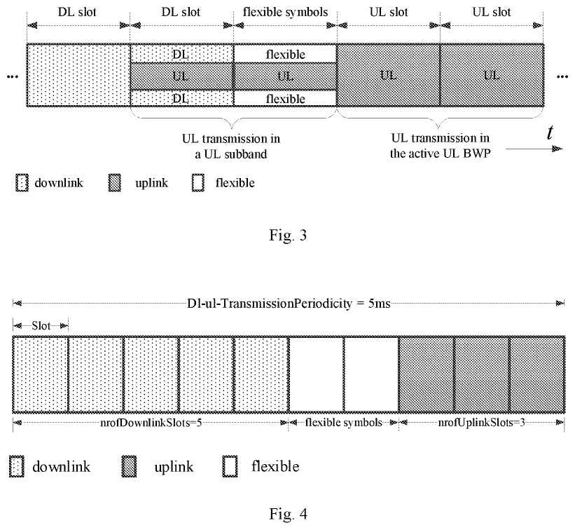

FIG. 3 illustrates an example for SBFD according to some embodiments of the present disclosure. In FIG. 3, there are five slots, the first slot and the second slot are DL slots, the fourth slot and the fifth slot are UL slots, and the symbols between the second slot and the fourth slot are flexible symbols. A UL subband is configured on the DL symbols of the second DL slot and on the flexible symbols. The UL transmission may be scheduled in the UL subband in SBFD symbols. In the UL slots, the UL transmission is scheduled in the active UL BWP.

It should be noted that although in FIG. 3, the UL subband is within the DL BWP, in some other embodiments, the UL subband may be out of the DL BWP.

The cell common UL/DL configuration, i.e. tdd-UL-DL-ConfigCommon is provided to the UE through system information. The tdd-UL-DL-ConfigCommon includes configurations of a transmission pattern, which may include the following:
a slot configuration period of P msec, which may be represented as: dl-ul-transmission-periodicity
a number of downlink slots dₛₗₒₜₛ, which may be represented as: nrofDownlinkSlots
a number of downlink symbols d_{sym}, which may be represented as: nrofDownlinkSymbols
a number of uplink slots uₛₗₒₜₛ, which may be represented as: nrofUplinkSlots
a number of uplink symbols u_{sym}, which may be represented as: nrofUplinkSymbols

A slot configuration period of P msec includes S slots. From the S slots, a first dₛₗₒₜₛ slots includes only downlink symbols and a last uₛₗₒₜₛ includes only uplink symbols. The d_{sym} symbols after the dₛₗₒₜₛ slots are downlink symbols. The u_{sym} symbols before the last uₛₗₒₜₛ are uplink symbols. The remaining symbols, the total number of the remaining symbols may be calculated as: (S−dₛₗₒₜ−uₛₗₒₜ)×N_{sym}−d_{sym}−u_{sym}, are flexible symbols, where N_{sym} is the number of symbols in a slot.

Here “flexible” means that the UE cannot make any assumptions on the transmission direction. Downlink control signal (i.e., PDCCH) should be monitored by the UE and if a scheduling message is found that is to schedule a UL/DL signal or channel in the flexible symbols, the UE should transmit/receive accordingly. In addition, the flexible symbols also served as guard period for the UEs to switch from DL reception to UL transmission.

FIG. 4 illustrates a TDD slot format determined based on a cell common UL/DL configuration, e.g. tdd-UL-DL-ConfigrationCommon, according to some embodiments of the present disclosure.

In FIG. 4, the slot configuration period is 5 ms, i.e. the value of the parameter: dl-ul-transmission-periodicity is 5 ms. The length of a slot is 0.5 ms, thus there are 10 slots within the slot configuration period.

The number of downlink slots, dₛₗₒₜₛ, is 5, i.e. the value of the parameter: nrofDownlinkSlots is 5, accordingly, the first three slots are downlink slots.

The number of downlink symbols d_{sym}, is not provided, thus, there is no downlink symbols after the downlink slots.

The number of uplink slots uₛₗₒₜₛ, is 3, i.e. the value of the parameter: nrofUplinkSlots is 3, accordingly, the last three slots are uplink slots.

The number of uplink symbols u_{sym}, is not provided, thus, there is no uplink symbols before the uplink slots.

The left symbols in the 10 slots are flexible symbols.

The UE may be further provided with a UE specific configuration RRC signaling, e.g. tdd-UL-DL-ConfigDedicated, which may indicate the format of the flexible symbols configured in tdd-UL-DL-ConfigDedicated, for example, the flexible symbols may be indicated as UL symbols, DL symbols, or flexible symbols, depending on traffic needs. The transmission direction of the non-flexible symbols configured in tdd-UL-DL-ConfigCommon cannot be overridden by the UE specific configuration RRC signaling.

Furthermore, UE may be further provided with a dynamically DCI signaling, which may dynamically change the transmission directions of the flexible symbols, which are configured by tdd-UL-DL-ConfigCommon or tdd-UL-DL-ConfigDedicated, if provided, to be UL symbol, DL symbols or flexible symbols. The DCI signaling may carry a slot format indicator (SFI), and may be transmitted to one or more devices.

For SBFD, one goal is that different UEs may be configured with different amount of SBFD symbols based on traffic needs. For example, UEs with heavy UL traffic may be configured with more SBFD symbols than UEs with light UL traffic. To achieve this goal, it should allow UE specifically configured SBFD symbols.

The present disclosure uses two schemes to achieve the UE specific configured SBFD symbols. The first scheme is that a set of SBFD symbols are configured cell specifically by a cell common signaling, and different UEs may determine the same or different subset of SBFD symbols from the set of cell common SBFD symbols through one or more UE specific signalings, such as the dedicated RRC signaling, or the DCI signaling. The second scheme is that there is no cell specifically configured SBFD symbols, and different UEs may determine a set of SBFD symbols through one or more UE specific signalings, such as the dedicated RRC signaling, or the DCI signaling.

For the above two schemes, the present disclosure proposes some solutions for flexibly enabling or disabling the UL subband in a symbol based on traffic needs. Hereinafter in the present disclosure, “enable,” “activate,” “make available,” or similar terms may be used interchangeably where appropriate. That is, the UL subband may be activated, or deactivated, may be made available, or unavailable, etc.

Hereinafter in the present disclosure, enabling a UL subband means that the UL subband is available for UL transmission, i.e., the symbol with UL subband is and disabling a UL subband means that the UL subband is not available at all. Besides, the legacy signaling on slot format indication and legacy procedure on slot format determination are expected to be reused for enabling/disabling of the UL subband to reduce the control overhead. Lastly, clear UE behaviour may be defined for the determined symbol format. These are the design targets of this invention.

The present disclosure proposes solutions regarding both semi-static enabling or disabling and dynamic enabling or disabling of UL subband in the symbol.

Specifically, it is proposed to utilize the existing signaling on the slot (or symbol) format indication, for example, the cell common signaling, tdd-UL-DL-ConfigCommon, the RRC dedicated signaling, tdd-UL-DL-ConfigDedicated, or the DCI signaling which may carry an SFI, to indicate the slot format or the symbol format to the UE. The solutions of the present disclosure provides some overridden principles to achieve flexible enabling/disabling of a subband for a symbol.

Hereinafter, the present disclosure describes the solutions with one symbol as an example, it should be noted that the solutions in the present disclosure also apply to more than one symbols, such as two symbols, ten symbols, etc.

### Solution 1

In solution 1, a symbol configured as a DL symbol by a cell common signaling, for example, tdd-UL-DL-ConfigCommon, is indicated as a SBFD symbol by another cell common signaling (e.g. a configuration signaling). In some other embodiment, one cell common signaling may indicate the symbol is a DL symbol and a SBFD symbol. The UE may further receive a UE specific RRC dedicated signaling, for example, tdd-UL-DL-ConfigDedicated, which may further indicate a symbol format (or a slot format) of the symbol. Hereinafter, a symbol format may include a DL symbol for DL reception in a BWP, a UL symbol for UL transmission in a UL BWP, a flexible symbol for either DL reception in a DL BWP or UL transmission in a UL BWP (or a UL subband), or a SBFD symbol. Based on the above indicated symbol formats (or the slot formats) of the symbol, the UE may determine the format of the symbol, and correspondingly determine the transmission direction of the symbol, as well as whether the UL subband is enabled or not, as follows.

Case 1-1 (DL→DL): the symbol is indicated as a DL symbol by the UE specific RRC signaling. The UE may determine the symbol is a DL symbol without a UL subband. The format of the symbol is DL for DL reception. The transmission direction of this symbol is DL, and the UL subband is disabled in this symbol. The UE may only be allowed to perform DL reception in this symbol, and the UE may not expect to receive a different symbol format for this symbol in a DCI signaling. The UE may further receive a DCI signaling, which also indicate the symbol is a DL symbol. Or, the UE may not receive a DCI signaling indicating the symbol format of the symbol.

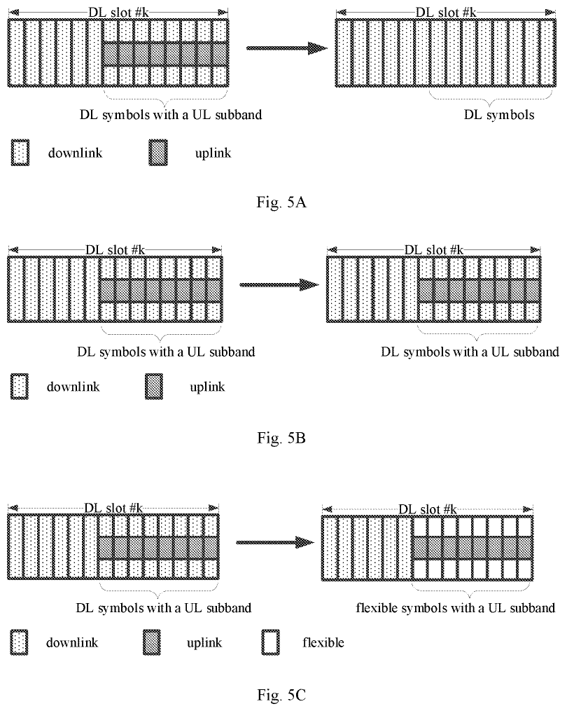

FIG. 5A illustrates a method of determining the format of symbols according to some embodiments of the present disclosure.

In FIG. 5A, DL slot #k includes 14 symbols, and the last eight symbols of DL slot #k are indicated as SBFD symbols. That is, there is a UL subband configured in these DL symbols. The format of the symbols of DL slot #k at this stage is shown as the left part in FIG. 5A. After receiving the UE specific RRC signaling, which indicates that the last eight symbols are DL symbols, the UE may only perform DL reception in these symbols, and UL subband is disabled in these symbols. The format of the symbols of DL slot #k at this stage is shown as the right part in FIG. 5A.

Case 1-2 (DL→UL): the symbol is indicated as a UL symbol by the UE specific RRC signaling. The UE may determine the symbol is a SBFD symbol. The transmission direction of this symbol is UL, and the UL subband is enabled in this symbol. The UE may only be allowed to perform UL transmission in the UL subband in this symbol, and the UE may not expect to receive a different symbol format for this symbol in a DCI signaling. The UE may further receive a DCI signaling, which may also indicate the symbol as a UL symbol. Or, the UE may not receive a DCI signaling indicating the symbol format of the symbol.

FIG. 5B illustrates a method of determining the format of symbols according to some embodiments of the present disclosure.

In FIG. 5B, DL slot #k includes 14 symbols, and the last eight symbols of DL slot #k are indicated as SBFD symbols. That is, there is a UL subband configured in these DL symbols. The format of the symbols of DL slot #k at this stage is shown as the left part in FIG. 5B. After receiving the UE specific RRC signaling, which indicates that these symbols are UL symbols, the UE may only perform UL transmission in the UL subband in these symbols, and UL subband is enabled in these symbols. The format of the symbols of DL slot #k at this stage is shown as the right part in FIG. 5B.

Case 1-3 (DL→flexible): the symbol is indicated as a flexible symbol by the UE specific RRC signaling. The UE may determine the symbol is a SBFD symbol. The transmission direction of this symbol is UL, and the UL subband is enabled in this symbol. The UE may only be allowed to perform UL transmission in the UL subband in this symbol. In some other embodiments, since the symbol is indicated as a flexible symbol, both UL transmission and DL reception are allowed in this symbol. The UE may determine the symbol is a SBFD symbol, or determine the format of the symbol is DL for DL reception flexibly, for example, based on traffic needs. The UE may perform either UL transmission within the UL subband or DL reception at a time since the UE performs in half-duplex mode.

FIG. 5C illustrates a method of determining the format of symbols according to some embodiments of the present disclosure.

In FIG. 5C, DL slot #k includes 14 symbols, and the last eight symbols of DL slot #k are indicated as SBFD symbols. That is, there is a UL subband configured in these DL symbols. The format of the symbols of DL slot #k at this stage is shown as the left part in FIG. 5C. After receiving the UE specific RRC signaling, which indicates that these symbols are flexible symbols, the UE may determine these symbols are SBFD symbols. The UE may only perform UL transmission in the UL subband in these symbols, and UL subband is enabled in these symbols. Alternatively, the UE may determine these symbols are SBFD symbols, or determine the format of these symbol are DL for DL reception flexibly, for example, based on traffic needs. The UE may perform either UL transmission within the UL subband or DL reception. The format of the symbols of DL slot #k at this stage is shown as the right part in FIG. 5C.

For case 1-3, in some other embodiments, the UE may further receive a DCI signaling, which indicate a format of the symbol, for example, by the carried SFI. The DCI may further override the symbol format of the symbol. Based on the format indicated in the DCI signaling, three cases are presented as follows:
Case 1-3-1 (DL→flexible→DL): the symbol is indicated as a DL symbol by the DCI signaling. The UE may determine the symbol is a DL symbol without a UL subband. The format of the symbol is DL for DL reception. The transmission direction of this symbol is DL, and the UL subband is disabled in this symbol. The UE may only be allowed to perform DL reception in this symbol.

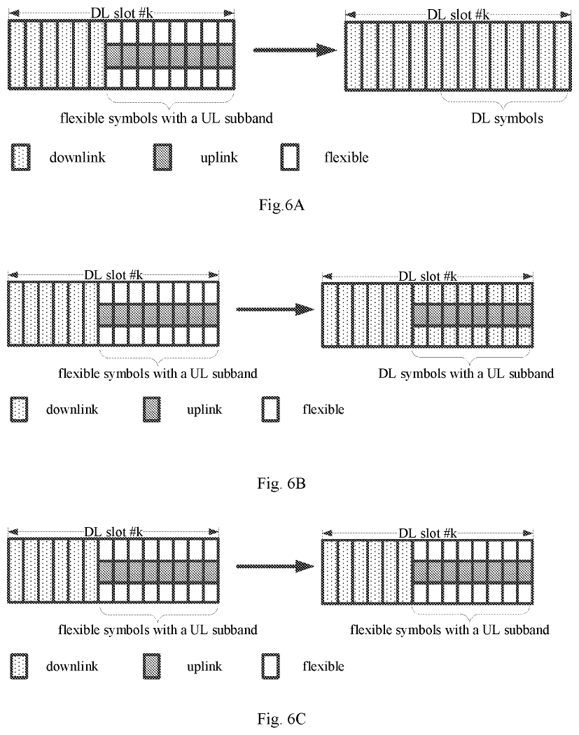

FIG. 6A illustrates a method of determining the format of symbols according to some embodiments of the present disclosure.

In FIG. 6A, DL slot #k includes 14 symbols, and the last eight symbols of DL slot #k are indicated as SBFD symbols. After receiving the UE specific RRC signaling, which indicates that the last eight symbols are flexible symbols, the UE may determine these symbols are flexible symbols with a UL subband. The format of the symbols of DL slot #k at this stage is shown as the left part in FIG. 6A. The UE may further receive a DCI signaling, which indicates these symbols are DL symbols, the UE may determine the format of the symbol is DL for DL reception. The transmission direction of these symbols is DL for DL reception, and these symbols are DL symbols without a UL subband. The UE may perform DL reception in these symbols. At this stage, the format of the symbols of DL slot #k is shown as the right part in FIG. 6A.

Case 1-3-2 (DL→flexible→UL): the symbol is indicated as a UL symbol by the DCI signaling. The UE may determine the symbol is a SBFD symbol. The transmission direction of this symbol is UL, and the UL subband is enabled in this symbol. The UE may only be allowed to perform UL transmission in the UL subband in this symbol.

FIG. 6B illustrates a method of determining the format of symbols according to some embodiments of the present disclosure.

In FIG. 6B, DL slot #k includes 14 symbols, and the last eight symbols of DL slot #k are indicated as SBFD symbols. After receiving the UE specific RRC signaling, which indicates that the last eight symbols are flexible symbols, the UE may determine these symbols are flexible symbols with a UL subband. The format of the symbols of DL slot #k at this stage is shown as the left part in FIG. 6B. The UE may further receive a DCI signaling, which indicates these symbols are UL symbols, the UE may determine these symbols are SBFD symbols. The transmission direction of these symbols is UL for UL transmission in the UL subband, and these symbols are SBFD symbols. The UE may perform UL transmission in the UL subband in these symbols. The format of the symbols of DL slot #k at this stage is shown as the right part in FIG. 6B.

In some embodiments, the UE may not expect that the symbol be indicated as a flexible symbol in the DCI signaling. In some other embodiments, the DCI signaling may indicate the symbol as a flexible symbol, and determining the format of symbols is described in case 1-3-3 below.

Case 1-3-3 (DL→flexible→flexible): the symbol is indicated as a flexible symbol by the DCI signaling. The UE may determine the symbol is a SBFD symbol. The transmission direction of this symbol is UL, and the UL subband is enabled in this symbol. The UE may only be allowed to perform UL transmission in the UL subband in this symbol. In some other embodiments, since the symbol is indicated as a flexible symbol, both UL transmission and DL reception are allowed in this symbol. The UE may determine the symbol is a SBFD symbol, or determine the format of the symbol is DL for DL reception flexibly, for example, based on traffic needs. The UE may perform either UL transmission within the UL subband or DL reception at a time since the UE performs in half-duplex mode.

FIG. 6C illustrates a method of determining the format of symbols according to some embodiments of the present disclosure.

In FIG. 6C, DL slot #k includes 14 symbols, and the last eight symbols of DL slot #k are indicated as SBFD symbols. After receiving the UE specific RRC signaling, which indicates that the last eight symbols are flexible symbols, the UE may determine these symbols are flexible symbols with a UL subband. The format of the symbols of DL slot #k at this stage is shown as the left part in FIG. 6C. The UE may further receive a DCI signaling, which indicates these symbols are flexible symbols, the UE may determine these symbols are SBFD symbols. The transmission direction of these symbols is UL for UL transmission in the UL subband, and these symbols are SBFD symbols. Alternatively, the UE may determine these symbols are SBFD symbols, or determine the format of these symbols is DL for DL reception flexibly. The format of the symbols of DL slot #k at this stage is shown as the right part in FIG. 6C.

With the above case 1-1 (indicating the format of the symbol as DL in the UE specific RRC signaling), case 1-2 (indicating the format of the symbol as UL in the UE specific RRC signaling), and case 1-3 (indicating the format of the symbol as flexible in the UE specific RRC signaling), semi-static enabling or disabling of the UL subband in the symbol is achieved by indicating the format of the symbol as one of DL, UL, or flexible by the UE specific RRC signaling.

With the above case 1-3-1 (indicating the format of the symbol as DL in the DCI signaling), case 1-3-2 (indicating the format of the symbol as UL in the DCI signaling), and case 1-3-3 (indicating the format of the symbol as flexible in the DCI signaling), the dynamic enabling or disabling of the UL subband in the symbol is achieved by indicating the format of symbol as flexible by the UE specific RRC signaling, and further indicating the format of symbol as one of DL, UL, or flexible by the DCI signaling.

### Solution 2

In solution 2, a symbol configured as a flexible symbol by a cell common signaling, for example, tdd-UL-DL-ConfigCommon, is indicated as a SBFD symbol by another cell common signaling (e.g. a configuration signaling). In some other embodiment, one cell common signaling may indicate the symbol is a flexible symbol and a SBFD symbol. The UE may further receive a UE specific RRC dedicated signaling, for example, tdd-UL-DL-ConfigDedicated, which may further indicate a symbol format (or a slot format) of the symbol. Based on the above indicated symbol formats (or the slot formats), the UE may determine the format of the symbol, as well as whether the UL subband is enabled or not, as follows.

Case 2-1 (flexible→DL): the symbol is indicated as a DL symbol by the UE specific RRC signaling. The UE may determine the symbol is a SBFD symbol, and the symbol is a DL symbol with a UL subband. The transmission direction of this symbol is UL for UL transmission in the UL subband, and the UL subband is enabled in this symbol. The UE may only be allowed to perform UL transmission in the UL subband in this symbol.

In some other embodiment, UE may determine the symbol is a DL symbol without a UL subband. The format of this symbol is DL, and the UL subband is disabled in this symbol. The UE may only be allowed to perform DL reception in this symbol.

The format of the symbol may not be overridden by other singling, for example, a DCI signaling that carries a SFI. The UE may further receive a DCI signaling, which may indicate the format of symbol, while the UE may not consider the format indicated by the DCI. Or, the UE may not receive a DCI signaling indicating the symbol format of the symbol.

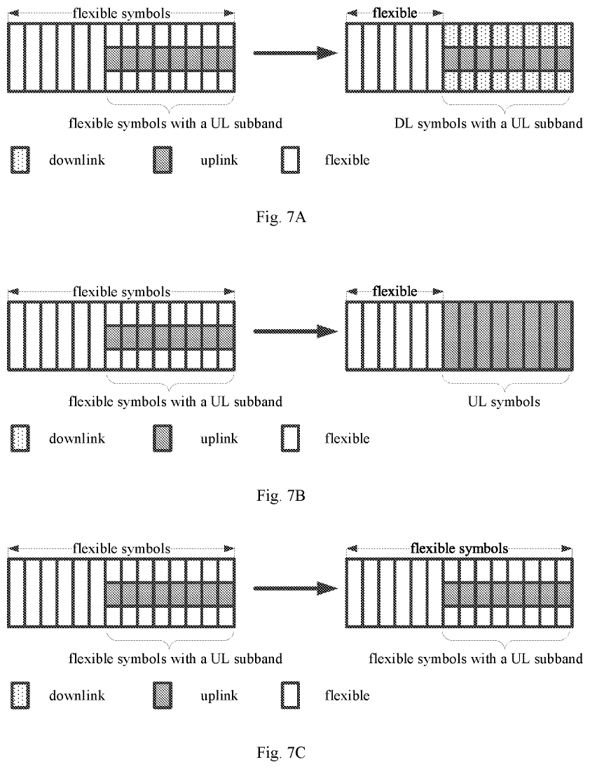

FIG. 7A illustrates a method of determining the format of symbols according to some embodiments of the present disclosure.

In FIG. 7A, there are 14 flexible symbols, and the last eight flexible symbols are indicated as SBFD symbols. That is, there is a UL subband configured in these flexible symbols. The format of the flexible symbols at this stage is shown as the left part in FIG. 7A. After receiving the UE specific RRC signaling, which indicates that these symbols are DL symbols, the UE may determine these symbols are SBFD symbols, and the transmission direction of these symbols is UL for UL transmission in the UL subband, and may only perform UL transmission in the UL subband in these symbols. The format of the symbols at this stage is shown as the right part in FIG. 7A.

Case 2-2 (flexible→UL): the symbol is indicated as a UL symbol by the UE specific RRC signaling. The UE may determine the symbol is a UL symbol. The format of the symbol is UL for UL transmission in the UL active BWP. The transmission direction of this symbol is UL in the UL active BWP, and the UL subband is disabled in this symbol. The UE may perform UL transmission in the UL active BWP in this symbol. The UE may not expect to receive a different symbol format in a DCI signaling. In the case that the UE further receives a DCI signaling, the DCI signaling may also indicate the symbol as a DL symbol. Or, the UE may not receive a DCI signaling indicating the symbol format of the symbol.

FIG. 7B illustrates a method of determining the format of symbols according to some embodiments of the present disclosure.

In FIG. 7B, there are 14 flexible symbols, and the last eight flexible symbols are indicated as SBFD symbols. That is, there is a UL subband configured in these flexible symbols. The format of the flexible symbols at this stage is shown as the left part in FIG. 7B. After receiving the UE specific RRC signaling, which indicates that these symbols are UL symbols, the UE may determine the format of the symbol is UL for UL transmission in the UL active BWP. The transmission direction of this symbol is UL for UL transmission in the UL BWP, and the UE may only perform UL transmission in the UL active BWP in these symbols. The format of the flexible symbols at this stage is shown as the right part in FIG. 7B.

Case 2-3 (flexible→flexible): the symbol is indicated as a flexible symbol by the UE specific RRC signaling. The UE may determine the symbol is a SBFD symbol. That is, there is a UL subband configured in these flexible symbols. The UE may only perform UL transmission in the UL subband in these symbols, and UL subband is enabled in these symbols. Alternatively, the UE may determine the symbol is a SBFD symbol, or determine the format of the symbol is DL for DL reception flexibly, for example, based on traffic needs. The UE may perform either UL transmission within the UL subband or DL reception at a time since the UE performs in half-duplex mode.

FIG. 7C illustrates a method of determining the format of symbols according to some embodiments of the present disclosure.

In FIG. 7C, there are 14 flexible symbols, and the last eight flexible symbols are indicated as SBFD symbols. That is, there is a UL subband configured in these flexible symbols. The format of the flexible symbols at this stage is shown as the left part in FIG. 7B. After receiving the UE specific RRC signaling, which indicates that these symbols are flexible symbols, the UE may only perform UL transmission in the UL subband in these symbols, and UL subband is enabled in these symbols. Alternatively, the UE may determine these symbols are SBFD symbols, or determine the format of these symbol are DL for DL reception flexibly, for example, based on traffic needs. The format of the flexible symbols at this stage is shown as the right part in FIG. 7C.

For case 2-3, in some other embodiments, the UE may further receive a DCI signaling, which indicate a format of the symbol. The DCI may further override the symbol format of the symbol. Based on the format indicated in the DCI signaling, three cases are presented as follows:

Case 2-3-1 (flexible→flexible→DL): the symbol is indicated as a DL symbol by the DCI signaling. The UE may determine the symbol is a DL symbol without a UL subband. The format of the symbol is DL for DL reception. The transmission direction of this symbol is DL, and the UL subband is disabled in this symbol. The UE may only be allowed to perform DL reception in this symbol.

Case 2-3-2 (flexible→flexible→UL): the symbol is indicated as a UL symbol by the DCI signaling. The UE may determine the symbol is a UL symbol. The format of the symbol is UL for UL transmission in a UL BWP. The transmission direction of this symbol is UL, and the UL subband is disabled in this symbol. The UE may only be allowed to perform UL transmission in the active UL BWP in this symbol.

Case 2-3-3 (flexible→flexible→flexible): the symbol is indicated as a flexible symbol by the DCI signaling. The UE may determine the symbol is a SBFD symbol. The transmission direction of this symbol is UL, and the UL subband is enabled in this symbol. The UE may only be allowed to perform UL transmission in the UL subband in this symbol. In some other embodiments, since the symbol is indicated as a flexible symbol, both UL transmission and DL reception are allowed in this symbol. The UE may determine the symbol is a SBFD symbol, or determine the format of the symbol is DL for DL reception flexibly, for example, based on traffic needs. The UE may perform either UL transmission within the UL subband or DL reception at a time since the UE performs in half-duplex mode.

With the above case 2-1 (indicating the format of the symbol as DL in the UE specific RRC signaling), case 2-2 (indicating the format of the symbol as UL in the UE specific RRC signaling), and case 2-3 (indicating the format of the symbol as flexible in the UE specific RRC signaling), semi-static enabling or disabling of the UL subband by the symbol is achieved by indicating the format of the symbol as one of DL, UL, or flexible by the UE specific RRC signaling.

With the above case 2-3-1 (indicating the format of the symbol as DL in the DCI signaling), case 2-3-2 (indicating the format of the symbol as UL in the DCI signaling), and case 2-3-3 (indicating the format of the symbol as flexible in the DCI signaling), the dynamic enabling or disabling of the UL subband in the symbol is achieved by indicating the format of symbol as flexible in the UE specific RRC signaling, and further indicating the format of symbol as one of DL, UL, or flexible in the DCI signaling.

### Solution 3

In solution 3, a symbol configured as a DL symbol by a UE specific RRC signaling, for example, tdd-UL-DL-ConfigDedicated, is indicated as a SBFD symbol by another UE specific RRC signaling (e.g. a configuration signaling). In some other embodiment, one UE specific RRC signaling may indicate the symbol is a DL symbol and a SBFD symbol. The UE may further receive a DCI signaling, which may include a SFI, that may further indicate a symbol format (or a slot format) of the symbol. Based on the above indicated symbol formats (or the slot formats), the UE may determine the format of the symbol, as well as whether the UL subband is enabled or not, as follows.

Case 3-1 (DL→DL): the symbol is indicated as a DL symbol by the DCI signaling. The UE may determine the format of the symbol is a DL symbol. The transmission direction of this symbol is DL for DL reception, and the UL subband is disabled in this symbol. The UE may only be allowed to perform DL reception in this symbol.

For example, in FIG. 5A, DL slot #k includes 14 symbols, and a UE specific RRC signaling may indicate that the last eight symbols of DL slot #k are SBFD symbols. That is, there is a UL subband configured in these DL symbols. The format of the symbols of DL slot #k at this stage is shown as the left part in FIG. 5A. After receiving the DCI signaling, which indicates that the last eight symbols are DL symbols, the UE may only perform DL reception in these symbols, and UL subband is disabled in these symbols. The format of the symbols of DL slot #k at this stage is shown as the right part in FIG. 5A.

Case 3-2 (DL→UL): the symbol is indicated as a UL symbol by the DCI signaling. The UE may determine the symbol is a SBFD symbol. The transmission direction of this symbol is UL in the UL subband, and the UL subband is enabled in this symbol. The UE may only be allowed to perform UL transmission in the UL subband in this symbol.

For example, in FIG. 5B, DL slot #k includes 14 symbols, and a UE specific RRC signaling may indicate that the last eight symbols of DL slot #k are SBFD symbols. That is, there is a UL subband configured in these DL symbols. The format of the DL slot #k is shown as the left part in FIG. 5B. After receiving the DCI signaling, which indicates that the last eight symbols are UL symbols, the UE may only perform UL transmission in the UL subband in these symbols, and UL subband is enabled in these symbols. The format of the DL slot #k is shown as the right part in FIG. 5B.

Case 3-3 (DL→flexible): the symbol is indicated as a flexible symbol by the DCI signaling. The UE may determine the symbol is a SBFD symbol. That is, the transmission direction of this symbol is UL in the UL subband, and the UL subband is enabled in this symbol. The UE may perform UL transmission in the UL subband in this symbol. In some other embodiments, since the symbol is indicated as a flexible symbol, both UL transmission and DL reception are allowed in this symbol. The UE may determine the symbol is a SBFD symbol, or determine the format of the symbol is DL for DL reception flexibly, for example, based on traffic needs. The UE may perform either UL transmission within the UL subband or DL reception at a time since the UE performs in half-duplex mode.

For example, in FIG. 5C, DL slot #k includes 14 symbols, and a UE specific RRC signaling may indicate that the last eight symbols of DL slot #k are SBFD symbols. That is, there is a UL subband configured in these DL symbols. The format of the symbols of DL slot #k at this stage is shown as the left part in FIG. 5C. After receiving the DCI signaling, which indicates that the last eight symbols are flexible symbols, the UE may only perform UL transmission in the UL subband in these symbols, and UL subband is enabled in these symbols. Alternatively, the UE may determine these symbols are SBFD symbols, or determine the format of these symbol are DL for DL reception flexibly, for example, based on traffic needs. The UE may perform either UL transmission within the UL subband or DL reception.

Semi-static enabling or disabling the UL subband in a symbol is achieved by configuring different SBFD symbols by the UE specific RRC signaling.

With the above case 3-1 (indicating the format of the symbol as DL in the DCI signaling), case 3-2 (indicating the format of the symbol as UL in the DCI signaling), and case 3-3 (indicating the format of the symbol as flexible in the DCI signaling), the dynamic enabling or disabling of the UL subband in a symbol is achieved by indicating the format of symbol as one of DL, UL, or flexible by the DCI signaling.

### Solution 4

In solution 4, a symbol configured as a flexible symbol by a UE specific RRC signaling, for example, tdd-UL-DL-ConfigDedicated, is indicated as a SBFD symbol by another UE specific RRC signaling (e.g. a configuration signaling). In some other embodiment, one UE specific RRC signaling may indicate the symbol is a flexible symbol and a SBFD symbol. The UE may further receive a DCI signaling, which may include a SFI, that may further indicate a symbol format (or a slot format) of the symbol. Based on the above indicated symbol formats (or the slot formats), the UE may determine the format of the symbol, as well as whether the UL subband is enabled or not, as follows.

Case 4-1 (flexible→DL): the symbol is indicated as a DL symbol by the DCI signaling. The UE may determine the symbol is a SBFD symbol, and the symbol is a DL symbol with a UL subband. The transmission direction of this symbol is UL in the UL subband, and the UL subband is enabled in this symbol. The UE may only be allowed to perform UL transmission in the UL subband in this symbol.

Alternatively, UE may determine the format of the symbol is a DL symbol. That is, the transmission direction of this symbol is DL, and the UL subband is disabled in this symbol. The UE may only be allowed to perform DL reception in this symbol.

For example, in FIG. 7A, there are 14 flexible symbols, and the last eight flexible symbols are indicated as SBFD symbols. That is, there is a UL subband configured in these flexible symbols. The format of the flexible symbols at this stage is shown as the left part in FIG. 7A. After receiving the DCI signaling, which indicates that these symbols are DL symbols, the UE may determine format of these symbols are DL. The transmission direction of this symbol is UL for UL transmission in the UL subband, and the UE may only perform UL transmission in the UL subband in these symbols. The format of the symbols at this stage is shown as the right part in FIG. 7A.

Case 4-2 (flexible→UL): the symbol is indicated as a UL symbol by the DCI signaling. The format of this symbol is UL for UL transmission in a UL BWP. The transmission direction of this symbol is UL in the UL active BWP, and the UL subband is disabled in this symbol. The UE may perform UL transmission in the UL active BWP in this symbol. The UE may not expect to receive a different symbol format in a DCI signaling. In the case that the UE further receives a DCI signaling, the DCI signaling may also indicate the symbol as a DL symbol. Or, the UE may not receive a DCI signaling indicating the symbol format of the symbol.

For example, in FIG. 7B, there are 14 flexible symbols, and the last eight flexible symbols are indicated as SBFD symbols. That is, there is a UL subband configured in these flexible symbols. The format of the flexible symbols at this stage is shown as the left part in FIG. 7B. After receiving the DCI signaling, which indicates that these symbols are UL symbols, the UE may determine the format of these symbols is UL. The transmission direction of these symbols is UL for UL transmission in the UL BWP, and the UE may only perform UL transmission in the UL active BWP in these symbols. The format of the flexible symbols at this stage is shown as the right part in FIG. 7B.

Case 4-3 (flexible→flexible): the symbol is indicated as a flexible symbol by the DCI signaling. The UE may determine the symbol is a SBFD symbol. That is, there is a UL subband configured in these flexible symbols. The UE may only perform UL transmission in the UL subband in these symbols, and UL subband is enabled in these symbols. Alternatively, the UE may determine the symbol is a SBFD symbol, or determine the format of the symbol is DL for DL reception flexibly, for example, based on UE implementation or based on scheduling. The UE may perform either UL transmission within the UL subband or DL reception at a time since the UE performs in half-duplex mode.

For example, in FIG. 7C, there are 14 flexible symbols, and the last eight flexible symbols are indicated as SBFD symbols. That is, there is a UL subband configured in these flexible symbols. The format of the flexible symbols at this stage is shown as the left part in FIG. 7B. After receiving the DCI signaling, which indicates that these symbols are flexible symbols, the UE may only perform UL transmission in the UL active subband in these symbols, and UL subband is enabled in these symbols. Alternatively, the UE may determine these symbols are SBFD symbols, or determine the format of these symbol are DL for DL reception flexibly, for example, based on traffic needs. The format of the flexible symbols at this stage is shown as the right part in FIG. 7C.

Semi-static enabling or disabling the UL subband in a symbol is achieved by configuring different SBFD symbols in the UE specific RRC signaling.

With the above case 4-1 (indicating the format of the symbol as DL in the DCI signaling), case 4-2 (indicating the format of the symbol as UL in the DCI signaling), and case 4-3 (indicating the format of the symbol as flexible in the DCI signaling), the dynamic enabling or disabling of the UL subband in a symbol is achieved by indicating the format of symbol as one of DL, UL, or flexible by the DCI signaling.

It should be noted that the above signaling, e.g. the cell common signaling, the UE specific RRC signaling, the DCI signaling, are explanatory, other signalings that can achieve the same functions may also be applied.

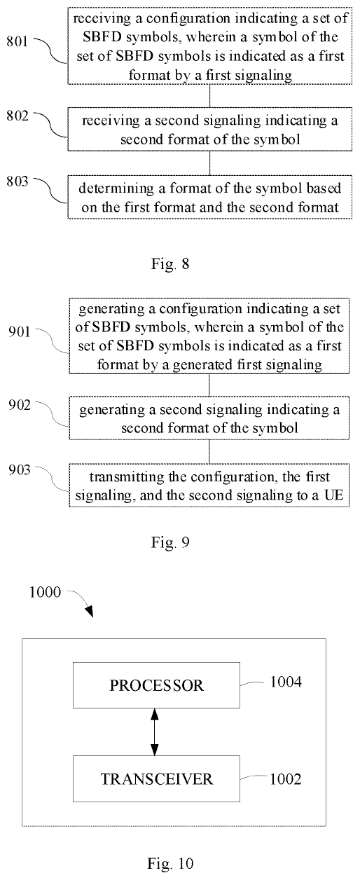

FIG. 8 illustrates a method performed by a UE for determining a format of a symbol according to some embodiments of the present disclosure.

In operation 801, the UE may receive a configuration indicating a set of SBFD symbols, wherein a symbol of the set of SBFD symbols is indicated with a first format by a first signaling; in operation 802, the UE may receive a second signaling indicating a second format of the symbol; in operation 803, the UE may determine a format of the symbol based on the first format and the second format.

FIG. 9 illustrates a method performed by a BS for determining a format of a symbol according to some embodiments of the present disclosure.

In operation 901, the BS may generate a configuration indicating a set of SBFD symbols, wherein a symbol of the set of SBFD symbols is indicated as a first format by a generated first signaling; in operation 902, the BS may generate a second signaling indicating a second format of the symbol; and in operation 903, the BS may transmit the configuration, the first signaling and the second signaling to a UE.

In some embodiments, the first format indicates that the symbol is a DL symbol, and the UE may perform one of the following:
determine the format of the symbol as DL for DL reception in the case that the second format indicates that the symbol is a DL symbol. For example, the cell common signaling may indicate the first format (which indicates that the symbol is a DL symbol), the UE specific RRC signaling may indicate the second format (which indicates that the symbol is a DL symbol), and the UE may determine the transmission direction of the symbol as DL for DL reception. In some other cases, the UE specific RRC signaling may indicate the first format, and the DCI signaling may indicate the second format.
determine the format of the symbol as a SBFD symbol in the case the second format indicates that the symbol is a UL symbol or a flexible symbol. For example, the cell common signaling may indicate the first format (which indicates that the symbol is a DL symbol), the UE specific RRC signaling may indicate the second format (which indicates that the symbol is a UL symbol or a flexible symbol), and the UE may determine the transmission direction of the symbol as UL for UL transmission in the UL subband. In some other cases, the UE specific RRC signaling may indicate the first format, and the DCI signaling may indicate the second format.
determine the symbol as a SBFD symbol or determine the format of the symbol as DL for DL reception flexibly in the case that the second format indicates the symbol is a flexible symbol. For example, the cell common signaling may indicate the first format (which indicates that the symbol is a DL symbol), the UE specific RRC signaling may indicate the second format (which indicates that the symbol is a flexible symbol), and the UE may determine the symbol is a SBFD symbol, or determine the format of the symbol is DL for DL reception flexibly. In some other cases, the UE specific RRC signaling may indicate the first format, and the DCI signaling may indicate the second format.

In some embodiments, the first format indicates that the symbol is a DL symbol, and the second format indicates that the symbol is a flexible symbol, and the UE may receive a third signaling indicating a third format of the symbol; and determine the transmission direction of the symbol based on the third format.

In some embodiments, the UE may perform one of the following:
determine the format of the symbol as DL for DL reception in the case that the third format indicates that the symbol is a DL symbol. For example, the cell common signaling may indicate the first format (which indicates that the symbol is a DL symbol), the UE specific RRC signaling may indicate the second format (which indicates that the symbol is a flexible symbol), and the DCI signaling may indicate the third format (which indicates that the symbol is a DL symbol), and the UE may determine the format of the symbol as DL for DL reception (the format of the symbols is as shown in the right part of FIG. 6A).
determine the format of the symbol as SBFD symbol in the case that the third format indicates the symbol is a UL symbol. For example, the cell common signaling may indicate the first format (which indicates that the symbol is a DL symbol), the UE specific RRC signaling may indicate the second format (which indicates that the symbol is a flexible symbol), and the DCI signaling may indicate the third format (which indicates that the symbol is a UL symbol), and the UE may determine the format of the symbol as SBFD symbol, and transmission direction of the symbol as UL for UL transmission in the UL subband (the format of the symbols is as shown in the right part of FIG. 6B).
determine the symbol as a SBFD symbol or determine the format of the symbol as DL for DL reception flexibly in the case that the third format indicates the symbol is a flexible symbol. For example, the cell common signaling may indicate the first format (which indicates that the symbol is a DL symbol), the UE specific RRC signaling may indicate the second format (which indicates that the symbol is a flexible symbol), and the DCI signaling may indicate the third format (which indicates that the symbol is a flexible symbol), and the UE may determine the symbol is a SBFD symbol, or determine the format of the symbol is DL for DL reception flexibly (the format of the symbols is shown in the right part of FIG. 6C).

In some embodiments, the first format indicates that the symbol is a flexible symbol, and the UE may perform one of the following:
determine the symbol as a SBFD symbol in the case the second format indicates the symbol is one of a DL symbol, or a flexible symbol. For example, the cell common signaling may indicate the first format (which indicates that the symbol is a flexible symbol), the UE specific RRC signaling may indicate the second format (which indicates that the symbol is a DL symbol), and the UE may determine format of the symbol as SBFD symbol, and the transmission direction of the symbol as UL for UL transmission in the UL subband. In some other cases, the UE specific RRC signaling may indicate the first format, and the DCI signaling may indicate the second format.
determine the format of the symbol as UL for UL transmission in a UL BWP in the case the second format indicates the symbol is a UL symbol. For example, the cell common signaling may indicate the first format (which indicates that the symbol is a flexible symbol), the UE specific RRC signaling may indicate the second format (which indicates that the symbol is a UL symbol), and the UE may determine the format of the symbol as UL for UL transmission in the UL BWP. In some other cases, the UE specific RRC signaling may indicate the first format, and the DCI signaling may indicate the second format.
determine the format of the symbol as DL for DL reception in the case the second format indicates the symbol is a DL symbol; or
determine symbol as a SBFD symbol or determine the format of the symbol as DL for DL transmission flexibly in the case that the second format indicates the symbol is a flexible symbol. For example, the cell common signaling may indicate the first format (which indicates that the symbol is a flexible symbol), the UE specific RRC signaling may indicate the second format (which indicates that the symbol is a flexible symbol), and the UE may determine the symbol is a SBFD symbol, or determine the format of the symbol is DL for DL reception flexibly. In some other cases, the UE specific RRC signaling may indicate the first format, and the DCI signaling may indicate the second format.

In some embodiments, the first format indicates that the symbol is a flexible symbol, and the second format indicates that the symbol is a flexible symbol, and the UE may: receive a third signaling indicating a third format of the symbol; and determine the transmission direction of the symbol based on the third format. In some embodiments, the UE may perform one of the following:
determine the format of the symbol as DL for DL reception in the case that the third format indicates the symbol is a DL symbol. For example, the cell common signaling may indicate the first format (which indicates that the symbol is a flexible symbol), the UE specific RRC signaling may indicate the second format (which indicates that the symbol is a flexible symbol), the DCI signaling may indicate the third format (which indicates that the symbol is a DL symbol), and the UE may determine the format of the symbol as DL for DL reception.
determine the format of the symbol as UL for UL transmission in a UL BWP in the case that the third format indicates the symbol is a UL symbol or a flexible symbol. For example, the cell common signaling may indicate the first format (which indicates that the symbol is a flexible symbol), the UE specific RRC signaling may indicate the second format (which indicates that the symbol is a flexible symbol), and the DCI signaling may indicate the third format (which indicates that the symbol is a UL symbol), the UE may determine the format of the symbol as UL for UL transmission in the UL subband.
determine the symbol as a SBFD symbol or determine the format of the symbol as DL for DL reception flexibly in the case that the third format indicates the symbol is a flexible symbol. For example, the cell common signaling may indicate the first format (which indicates that the symbol is a flexible symbol), the UE specific RRC signaling may indicate the second format (which indicates that the symbol is a flexible symbol), and the DCI signaling may indicate the third format (which indicates that the symbol is a flexible symbol), the UE may determine the symbol is a SBFD symbol, or determine the format of the symbol is DL for DL reception flexibly.

In some embodiments, the third signaling includes a DCI signaling.

In some embodiments, the configuration for the SBFD symbols includes a cell common signaling, the first signaling includes a cell common signaling, and the second signaling includes a UE specific RRC signaling.

In some embodiments, the configuration for the SBFD symbols includes a cell common signaling, the first signaling includes a UE specific RRC signaling, and wherein the second signaling includes a DCI signaling.

FIG. 10 illustrates a simplified block diagram of an apparatus according to some embodiments of the present disclosure.

As shown in FIG. 10, an example of the apparatus 1000 may include at least one processor 1004 and at least one transceiver 1002 coupled to the processor 1004. The apparatus 1000 may be a UE, a BS, or any other device with similar functions.

Although in this figure, elements such as the at least one transceiver 1002 and processor 1004 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1004 may interact with each other so as to perform the operations of the UE described in any of FIGS. 1-9. In some embodiments of the present disclosure, the apparatus 1000 may be a BS. The transceiver 1002 and the processor 1004 may interact with each other so as to perform the operations of the BS described in any of FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1004 to implement the method with respect to the UE as described above. For example, the computer-executable instructions, when executed, cause the processor 1004 interacting with transceiver 1002 to perform the operations of the UE described in any of FIGS. 1-9.

In some embodiments of the present disclosure, the non-transitory computer-readable medium may have stored thereon computer-executable instructions to cause the processor 1004 to implement the method with respect to the BS as described above. For example, the computer-executable instructions, when executed, cause the processor 1004 interacting with transceiver 1002 to perform the operations of the BS described in any of FIGS. 1-9.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a configuration indicating a set of subband full duplex (SBFD) symbols, wherein a symbol of the set of SBFD symbols is indicated as a first format by a first signaling;
receive a second signaling indicating a second format of the symbol; and
determine a format of the symbol based on the first format and the second format.

2. The UE of claim 1, wherein the first format indicates that the symbol is a downlink (DL) symbol, and the at least one processor is further configured to cause the UE to:
determine a format of the symbol as DL for DL reception in a case that the second format indicates that the symbol is a DL symbol;
determine the symbol is a SBFD symbol in a case the second format indicates that the symbol is a UL symbol or a flexible symbol; or
determine the symbol is a SBFD symbol or determine the format the symbol as DL for DL reception flexibly in a case that the second format indicates the symbol is a flexible symbol.

3. The UE of claim 1, wherein the first format indicates that the symbol is a downlink (DL) symbol, and the second format indicates that the symbol is a flexible symbol, and the at least one processor is further configured to cause the UE to:
receive a third signaling indicating a third format of the symbol; and
determine the format of the symbol based on the third format.

4. The UE of claim 3, wherein the at least one processor is further configured to cause the UE to:
determine a format of the symbol as downlink (DL) for DL reception in a case that the third format indicates that the symbol is a DL symbol;
determine the symbol is a SBFD symbol in a case that the third format indicates the symbol is a UL symbol; or
determine the symbol is a SBFD symbol or determine the format the symbol as DL for DL reception flexibly in a case that the third format indicates the symbol is a flexible symbol.

5. The UE of claim 1, wherein the first format indicates that the symbol is a flexible symbol, and the at least one processor is further configured to cause the UE to:
determine the symbol is a SBFD symbol in a case that the second format indicates the symbol is one of a downlink (DL) symbol, or a flexible symbol;
determine the format of the symbol as uplink (UL) for UL transmission in a UL bandwidth part (BWP) in a case that the second format indicates the symbol is a UL symbol;
determine the format of the symbol as DL for DL reception in a case that the second format indicates the symbol is a DL symbol; or
determine the symbol is a SBFD symbol or determine the format of the symbol as DL for DL transmission flexibly in a case that the second format indicates the symbol is a flexible symbol.

6. The UE of claim 1, wherein the first format indicates that the symbol is a flexible symbol, and the second format indicates that the symbol is a flexible symbol, and the at least one processor is further configured to cause the UE to:
receive a third signaling indicating a third format of the symbol; and
determine the format of the symbol based on the third format.

7. The UE of claim 6, wherein the at least one processor is further configured to cause the UE to:
determine the format of the symbol is downlink (DL) for DL reception in a case that the third format indicates the symbol is a DL symbol;
determine the format of the symbol is uplink (UL) for UL transmission in a UL BWP in a case that the third format indicates the symbol is a UL symbol or a flexible symbol; or
determine the symbol as a SBFD symbol or determine the format of the symbol is DL for DL reception flexibly in a case that the third format indicates the symbol is a flexible symbol.

8. The UE of claim 6, wherein the third signaling includes a downlink control information (DCI) signaling.

9. The UE of claim 1, wherein the configuration includes a cell common signaling, wherein the first signaling includes a cell common signaling, and wherein the second signaling includes a UE specific radio resource control (RRC) signaling.

10. The UE of claim 1, wherein the configuration for the SBFD symbols includes a cell common signaling, wherein the first signaling includes a UE specific radio resource control (RRC) signaling, and wherein the second signaling includes a downlink control information (DCI) signaling.

11. A base station for wireless communication, comprising:
at least one memory; and
at least one processor coupled with the at least one memory and configured to cause the base station to:
generate a configuration indicating a set of subband full duplex (SBFD) symbols, wherein a symbol of the set of SBFD symbols is indicated as a first format by a generated first signaling;
generate a second signaling indicating a second format of the symbol; and
transmit the configuration, the first signaling, and the second signaling.

12. The base station of claim 11, wherein the first format indicates that the symbol is a downlink (DL) symbol, and the second format indicates that the symbol is a flexible symbol, and the at least one processor is further configured to cause the base station to:
generate a third signaling indicating a third format of the symbol; and
transmit the third signaling.

13. The base station of claim 12, wherein the third signaling includes a DL control information (DCI) signaling.

14. The base station of claim 11, wherein the configuration includes a cell common signaling, wherein the first signaling includes a cell common signaling, and wherein the second signaling includes a user equipment specific radio resource control (RRC) signaling.

15. A method performed by a user equipment (UE), the method comprising:
receiving a configuration indicating a set of subband full duplex (SBFD) symbols, wherein a symbol of the set of SBFD symbols is indicated as a first format by a first signaling;
receiving a second signaling indicating a second format of the symbol; and
determining a format of the symbol based on the first format and the second format.

16. The method of claim 15, wherein the first format indicates that the symbol is a downlink (DL) symbol, and the method further comprises:
determining a format of the symbol as DL for DL reception in a case that the second format indicates that the symbol is a DL symbol;
determining the symbol is a SBFD symbol in a case the second format indicates that the symbol is a UL symbol or a flexible symbol; or
determining the symbol is a SBFD symbol or determine the format the symbol as DL for DL reception flexibly in a case that the second format indicates the symbol is a flexible symbol.

17. The method of claim 15, wherein the first format indicates that the symbol is a downlink (DL) symbol, and the second format indicates that the symbol is a flexible symbol, and the method further comprises:
receiving a third signaling indicating a third format of the symbol; and
determining the format of the symbol based on the third format.

18. The method of claim 15, wherein the first format indicates that the symbol is a flexible symbol, and the method further comprises:
determining the symbol is a SBFD symbol in a case that the second format indicates the symbol is one of a downlink (DL) symbol, or a flexible symbol;
determining the format of the symbol as uplink (UL) for UL transmission in a UL bandwidth part (BWP) in a case that the second format indicates the symbol is a UL symbol;
determining the format of the symbol as DL for DL reception in a case that the second format indicates the symbol is a DL symbol; or
determining the symbol is a SBFD symbol or determine the format of the symbol as DL for DL transmission flexibly in a case that the second format indicates the symbol is a flexible symbol.

19. A method performed by a base station, the method comprising:
generating a configuration indicating a set of subband full duplex (SBFD) symbols, wherein a symbol of the set of SBFD symbols is indicated as a first format by a generated first signaling;
generating a second signaling indicating a second format of the symbol; and
transmitting the configuration, the first signaling, and the second signaling.

20. The method of claim 19, wherein the first format indicates that the symbol is a downlink (DL) symbol, and the second format indicates that the symbol is a flexible symbol, and the method further comprises:
generating a third signaling indicating a third format of the symbol; and
transmitting the third signaling.
